(19) United States
(12) Patent Application Publication
(10) Pub. No.: US 2013/0204751 A1
(43) Pub. Date: Aug. 8, 2013

(54) COMPUTER BASED SYSTEM AND METHOD FOR RECONCILING REQUISITION ORDERS AND GOODS RECEIPTS

(71) Applicants: SACHIN SHARMA, MUMBAI (IN); PRASAD GUPTE, MUMBAI (IN)

(72) Inventors: SACHIN SHARMA, MUMBAI (IN); PRASAD GUPTE, MUMBAI (IN)

(21) Appl. No.: 13/536,102

(22) Filed: Jun. 28, 2012

(30) Foreign Application Priority Data
Feb. 8, 2012 (IN) 354/MUM/2012

(51) Int. Cl. G06Q 10/08

(52) U.S. Cl. 705/28

(57) ABSTRACT

A computer based procurement system including a processor unit and a computer readable medium storing instructions executable by the processor unit. The system permits receiving requisition orders for goods. The system also permits receiving inputs confirming receipt of goods, wherein the inputs confirming the receipt are generated by flipping the associated requisition orders. Moreover, the system permits analyzing the goods receipts against the requisition orders using one or more predetermined criteria and generating indication for missing goods.

### CROSS-REFERENCE TO RELATED APPLICATION

The present invention claims priority to Indian Patent Application No. 354/MUM/2012, entitled “System and Method for Flipping Requisition Orders into Goods Receipt in a Verifiable Manner,” filed Feb. 8, 2012, pending, the entire specification of which is expressly incorporated herein by reference.

### BACKGROUND OF THE INVENTION

The present invention is generally related to techniques for procurement of goods in organizations. More specifically, the present invention provides computer based requisition orders and goods receipts reconciliation system and method.

Conventionally, the procurement function in organizations used to be quite centralized. The individuals/departments needing to procure goods would typically route such requests through the centralized procurement department. The centralized procurement department would typically receive the goods and then forward them to the requesters. The procurement department would also interact with the vendors to fill their invoices. For example, conventionally, the Enterprise Resource Planning (ERP) systems have operated in centralized manner.

However, with the growing popularity of peer-to-peer (P2P) systems, it now becomes possible for the requesters (for example, people/departments those who request goods for use/consumption) to receive goods at their desk (often called “desktop receiving”). This reduces the workload for the buyer/store-keeper in the procurement department. It also reduces delay in procurement. However, distributed nature of desktop receiving presents challenges in accounting for the received goods. Accordingly, improved procurement techniques are required to perform desktop receiving without incurring errors and inconsistencies.

### SUMMARY OF THE INVENTION

With the growing popularity of peer-to-peer (P2P) systems in enterprise procurement, it becomes possible for the requesters (those who request goods) to receive goods at their desk (often called “desktop receiving”). The desktop receiving eliminates the need for the centralized procurement function/department to be in the receiving path. This can increase efficiency of procurement. However, the distributed nature of the desktop receiving also presents challenges in accounting for the goods that are actually received.

It is an object of the present invention to provide computer based system and method to facilitate desktop receiving. The techniques according to the present invention advantageously facilitate desktop receiving while reducing errors and inconsistencies in the accounting process. More particularly, the present invention provides system and method to reconcile requisition requests with goods receipts during the desktop receiving.

In a specific embodiment of the present invention, a computer based system for desktop ordering is provided. The system comprises a processor unit. Moreover, the system comprises a computer readable medium storing instructions. The instructions are executable by the processor unit to perform the steps of receiving requisition orders for goods and receiving inputs confirming receipt of goods, wherein the inputs confirming the receipt are generated by flipping the associated requisition orders. Moreover, the instructions are executable to perform the steps of analyzing the goods receipts against the requisition orders using one or more predetermined criteria and generating indication for missing goods, based at least on the analyzing. Associated methods are also provided in specific embodiments.

These and other various objects, features, advantages, and benefits of the present invention can be more fully appreciated with reference to the detailed description and accompanying drawings that follow.

### BRIEF DESCRIPTION OF THE DRAWINGS

Embodiments of the present invention are illustrated in the figures of the accompanying drawings. The figures are provided to aid good understanding of the present invention. Notably, the figures are exemplary rather than limiting. Based on the present disclosure, person of ordinary skill in the art can contemplate various alternatives, variations and modifications to the illustrated embodiments within the scope of the invention.

FIG. 1 illustrates an exemplary computer network environment appropriate for a specific embodiment of the present invention;

FIG. 2 illustrates an exemplary computer apparatus that can provide a computing platform to practice specific embodiments of the present invention;

FIG. 3 illustrates an exemplary schematic of a desktop receiving system according to a specific embodiment of the present invention;

FIG. 4 illustrates an exemplary flow of steps in a desktop receiving method according to a specific embodiment of the present invention;

FIG. 5A illustrates exemplary computer screenshot for filling requisition order according to a specific embodiment of the present invention;

FIG. 5B illustrates exemplary computer screenshot for confirming goods receipt (flipping requisition order) according to a specific embodiment of the present invention; and

FIG. 5C illustrates exemplary email alert for missing goods receipt according to a specific embodiment of the present invention.

### DETAILED DESCRIPTION OF THE INVENTION

While desktop receiving can increase efficiency of the enterprise procurement process, it also presents certain challenges in accounting for the goods received. In particular, due to the distributed nature of the desktop receiving, it is often difficult to reconcile the requisition requests with the goods receipts. For example, in desktop receiving, even though the goods receipts can happen in a distributed fashion, the accounting is typically centralized. That is, it could still be the centralized procurement function which will receive invoices from suppliers, which they will have to verify so that the finance department can fulfill these invoices. For this, the procurement department or the finance department would need precise information on goods/services which were received in a distributed manner. In order for the desktop receiving to be successful, it is essential to minimize errors and inconsistencies between the requisition orders and the goods receipts.

The present invention provides system and method for desktop receiving which can minimize such errors and inconsistencies. More particularly, the computer based system and the method of the present invention facilitates reconciling the requisition orders and good receipts, even though the goods receipts can happen in a distributed manner.

The following detailed description of the invention refers at various places to the accompanying drawings and specific environments, applications, platforms, examples, computer screenshots, and implementations. The detailed description is provided for thorough understanding of the present invention and is illustrative rather than limiting.

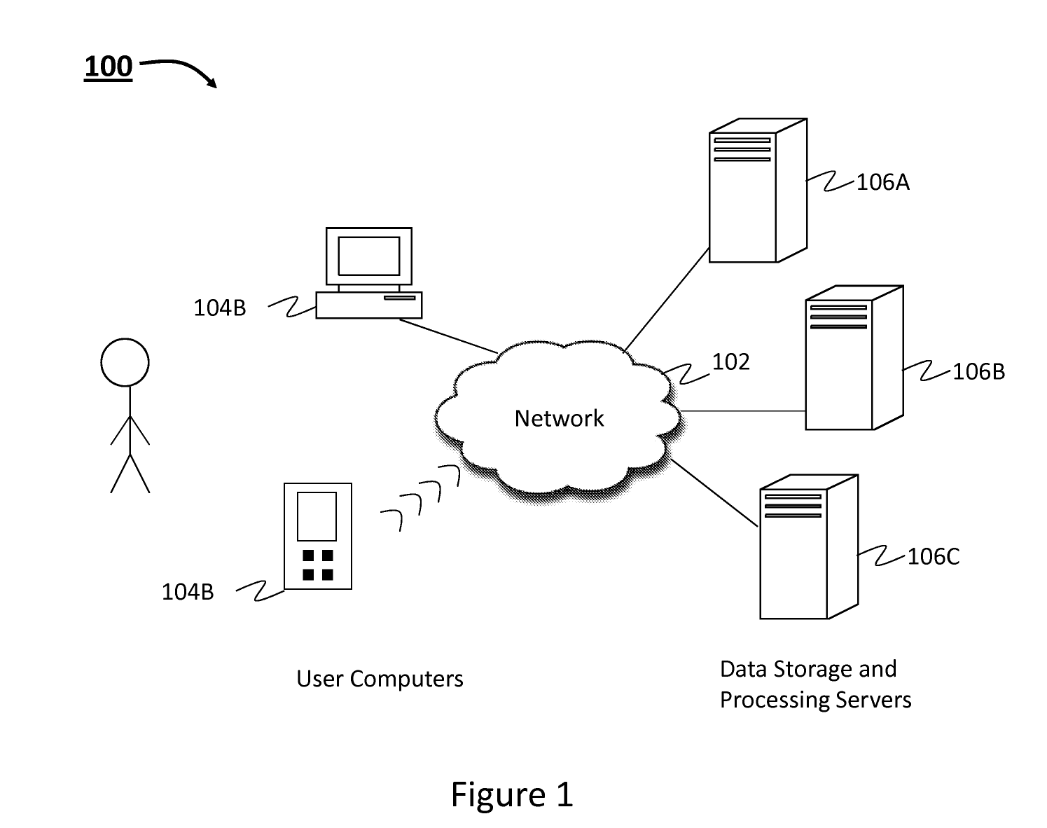

FIG. 1 illustrates an exemplary networked computer system 100 which can provide an environment to practice certain specific embodiments of the present invention. As shown in FIG. 1, multiple end user computer systems 104 and multiple server computer systems 106 can be coupled to a computer network 102. For example, the computer network 102 can be a private network of the organization. In alternative embodiment, the computer network 102 can include the local area network (LAN); and in yet an alternative embodiment it can include the Internet. The end user computer systems 104 can include without limitation desktop computers, laptop computers, personal digital assistant (PDAs), tablets, and smart phones. The computer systems 104, 106, etc. can exchange information using the computer network 102.

The servers 106 store digitized content which can be accessed (e.g., read, downloaded, searched, changed, etc. as appropriate) over the computer network. A specific portion of the content is often identified using a hyperlink. The content stored in one server can also be accessed by another server and by the end user computer system. Popular techniques for accessing the content include HTTP and (HyperText Transfer Protocol) and HTTPS (HyperText Transfer Protocol Secure), though other techniques can also be used. Access to some portions of the content may require authentication and/or authorization for access.

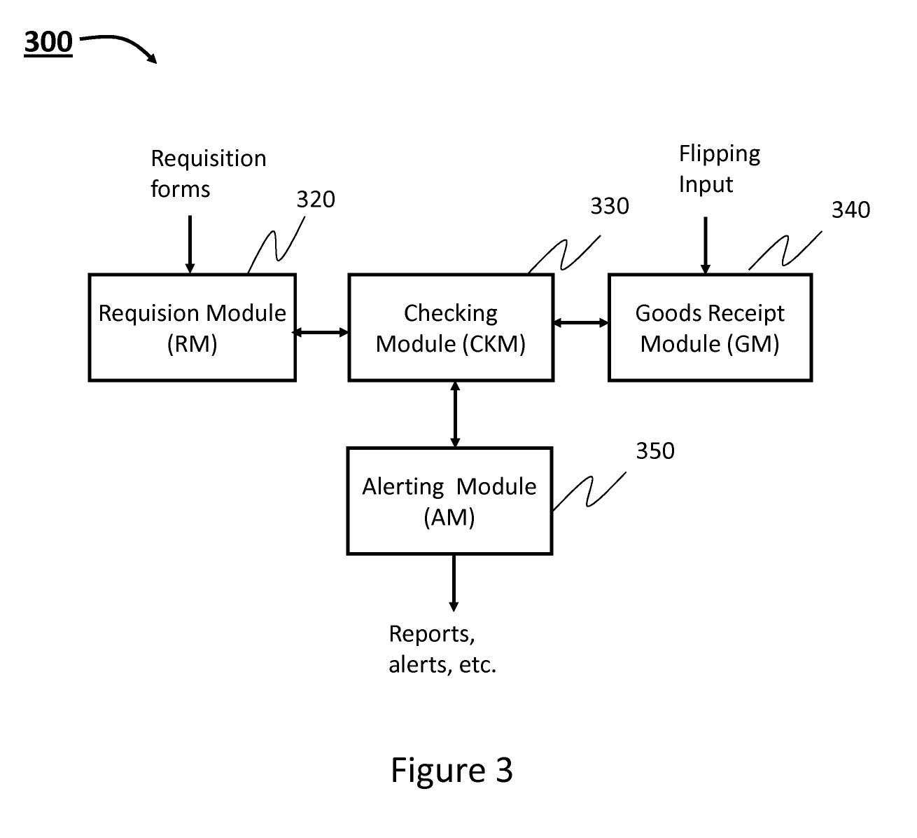

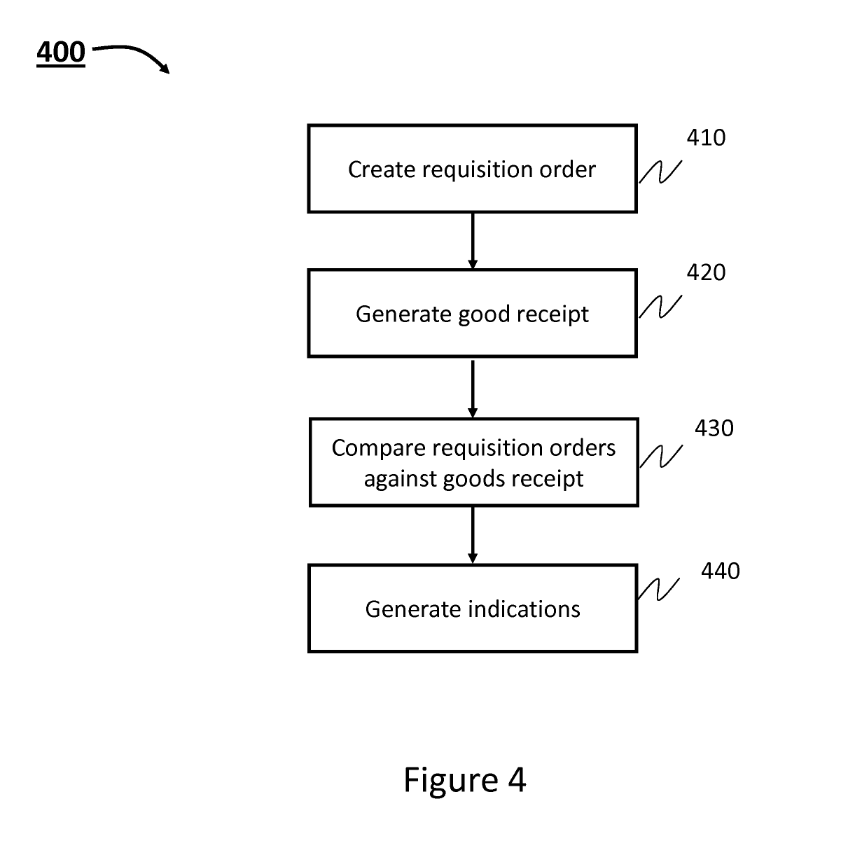

Depending upon embodiments of the present invention, the servers 106 and the computer systems 104 can be configured to perform certain acts. For example, the servers 106 and the computer systems 104 can include software which can facilitate performing these acts. These acts can include various acts performed by the various modules illustrated in FIG. 3. Moreover, these acts can include various acts performed by during the process illustrated in FIG. 4.

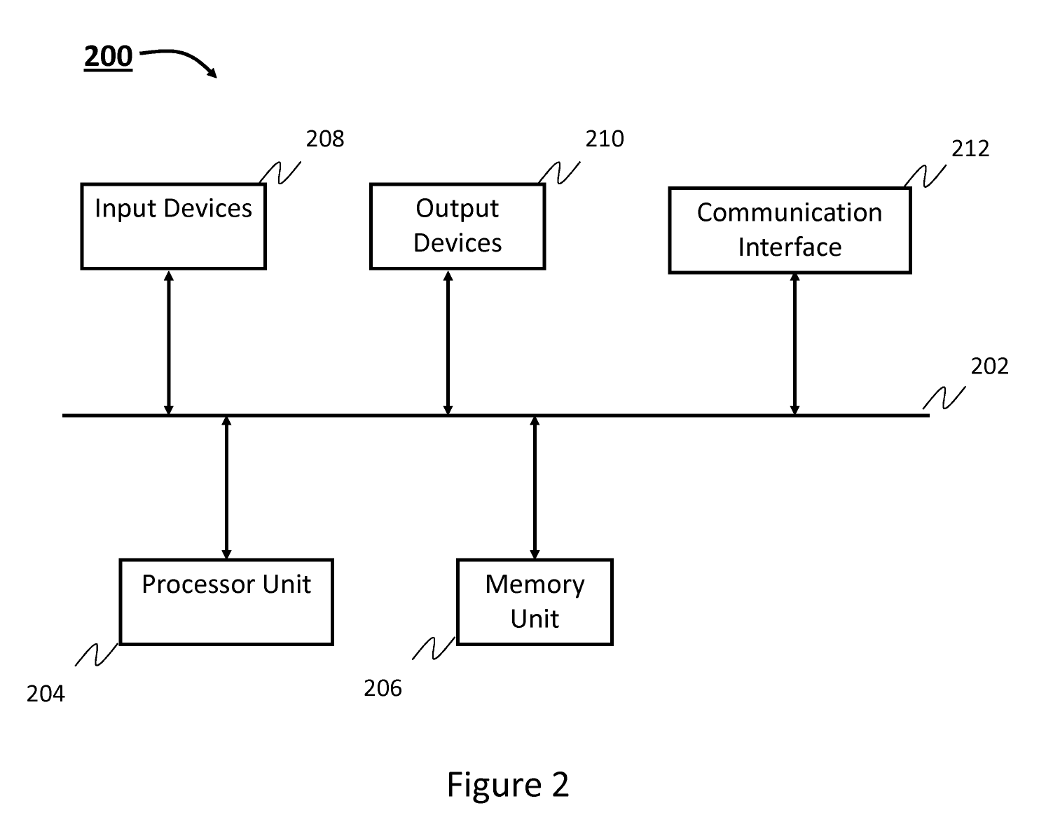

FIG. 2 illustrates an exemplary implementation of any of the servers 106 or any of the end user computer system 104, according to an embodiment of the present invention. The bus 202 permits communication among the components. The processor unit 204 may include one or more microprocessors, microcontrollers, RISC processors, CISC processors, etc. The processor unit can interpret and execute instructions. The memory unit 206 may include any type of one or more volatile storage devices, for example, random access memory (RAM). The memory unit 206 may in addition or alternatively include any type of one or more persistent storage devices, for example read only memory (ROM), read write memory, hard disc, flash memory, etc. The memory unit stores information and instructions for execution by the processor unit 204.

The input devices 208 may include one or more mechanisms that permit an operator to input information, such as a keyboard, mouse, pen, magnetic drives, optical drives, etc. The output devices 210 may include one or more mechanisms that output information to the operator, including a display, a printer, a speaker, etc. The communication interface 212 may include any transceiver mechanism that enables communication with other devices and systems via a network. For example, the communication interface can include Ethernet interface, optical network interface, wireless interface, etc.

FIG. 3 illustrates an exemplary schematic 300 of a procurement system according to an embodiment of the present invention. As shown in FIG. 3, the system 300 comprises various modules. Each of these modules can be a hardware module, a software module, or combination thereof. Moreover, depending upon the embodiment, each of the modules can reside on a single computer system or can be distributed across a plurality of interconnected computers.

There is provided a Requisition Module (RM) (320) for receiving filled requisition form. The RM is responsible for presenting requisition form to the requester of goods, which includes information fields relating to the requested goods. The requisition form can be filled by the procurement department person or it can be filled in by the user who requests the goods. For example, the requester can fill the form on the end user computer systems (104). As merely an example, web browser or another application on the end user computer systems can facilitate presenting the form to the user and filling the form. After the form is filled, the RM can facilitate submitting the form. For example, the submitted form can be forwarded over the computer network (102) and stored in one of the servers (106) for order processing.

There is also provided a module for generating goods receipt, called as Goods Receipt Module (GRM) (340). The GRM is responsible for generating goods receipts in respect of the items supplied by the supplier that were actually received by the requester. The GRM thus maintains record of goods receipts. In a specific embodiment, the goods receipt is generated by way of presenting the respective requisition form to the user and permitting the user to acknowledge its receipt (also called as “flipping” the requisition order into good receipt). The records of goods receipts can be stored in one of the servers (106).

The system also includes a module for checking the goods receipts against the requisition requests, called as ChecKing Module (CKM) (330). In a specific embodiment, the checking module can match requisition requests with goods receipts to identify the goods that were actually received and to identify the requisition requests that are not yet fulfilled. The CKM can access the RM and GRM data to perform the comparison.

Moreover, the system includes a module called as Alerting Module (AM) (350). The AM is responsible for generating reports and/or alerts based upon the comparison performed by the CKM. The AM can generate periodic or on-demand reports for the procurement/finance departments. A typical report can indicate the goods receipts in relation to the requisition orders. This can facilitate verifying the goods receipts prior to paying supplier invoices. It can also facilitate identifying the missing goods. In an alternative embodiment, the AM can generate alerts if goods receipts are not yet confirmed for creation requisition orders. For example, if the goods receipt is not yet confirmed even after the expected date of receipt an alert may be generated. Expected date of receipt is often stated in the purchase order (e.g., purchase order that is generated based upon the filled requisition request), it can be pre-contracted with the supplier, it can be the fulfillment time period agreeable to the receiver, etc. The alert may be communicated to the user (to remind the user to confirm the goods receipt if that is not already done) and/or the store keeper (to let the store keeper know about missing goods).

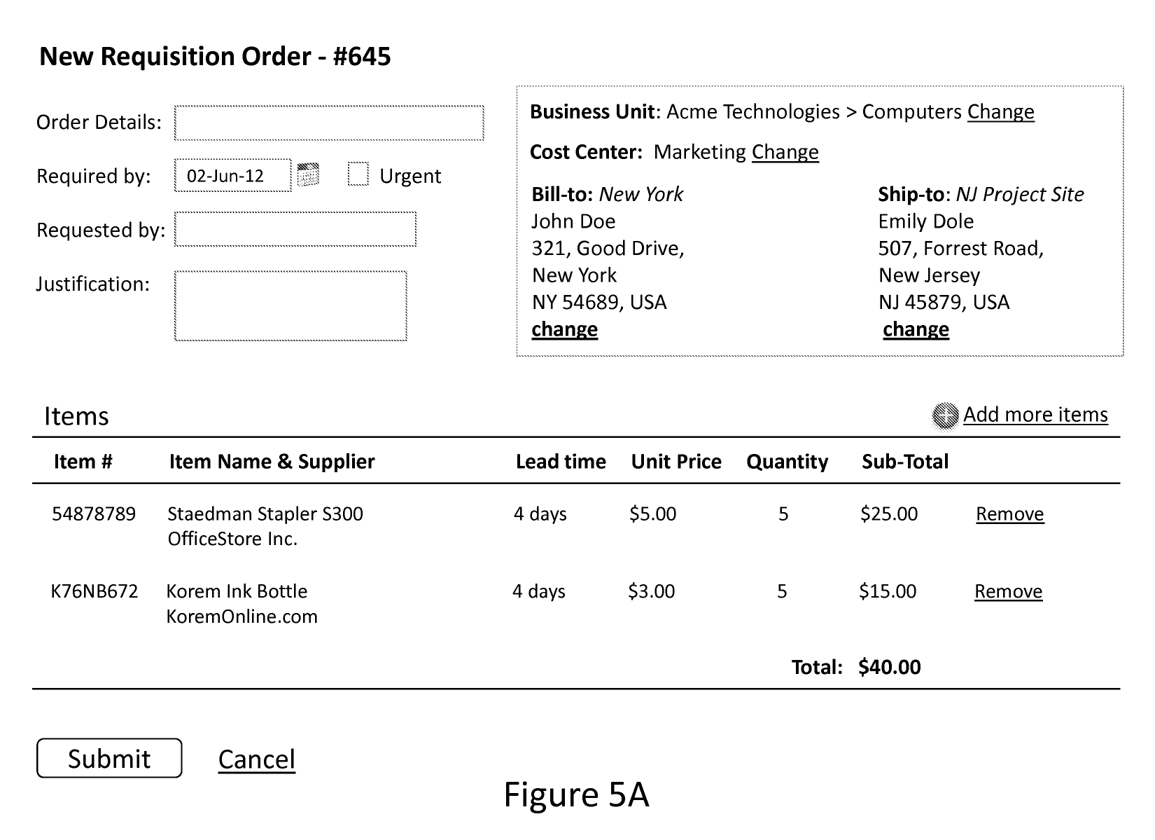

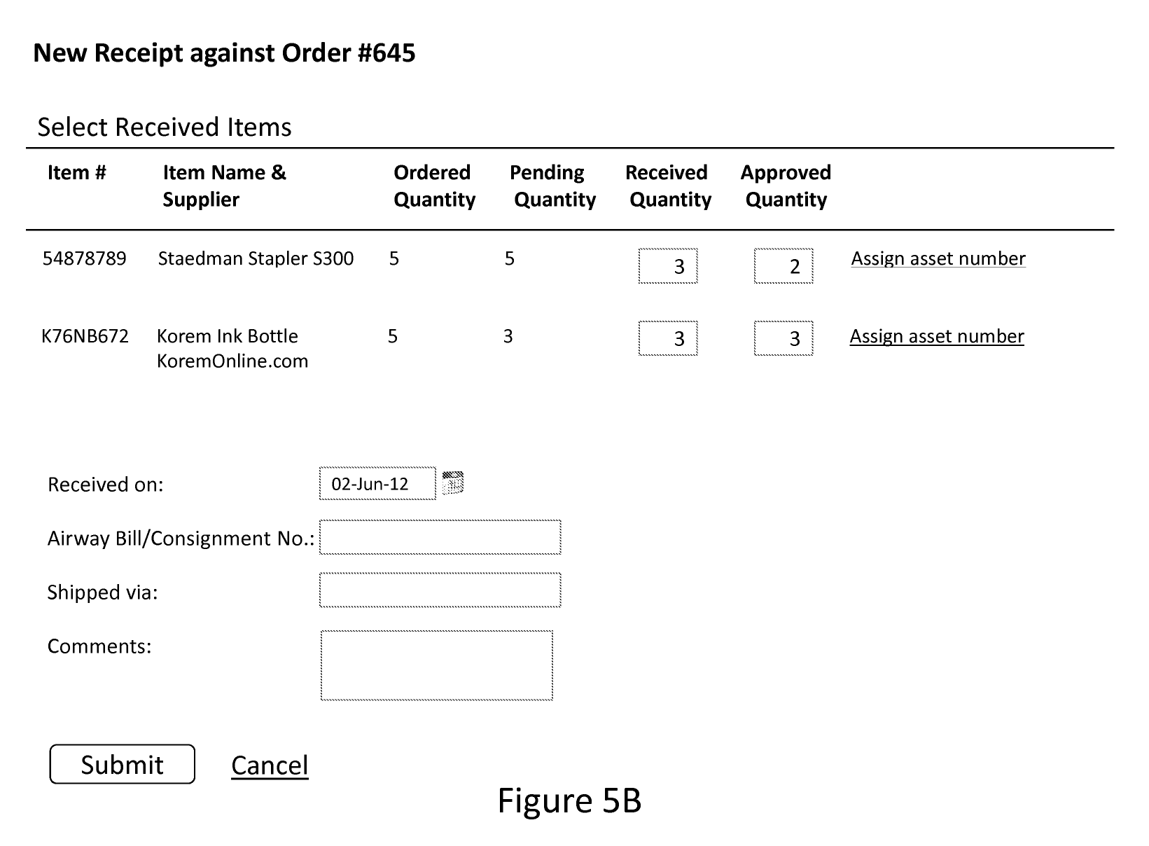

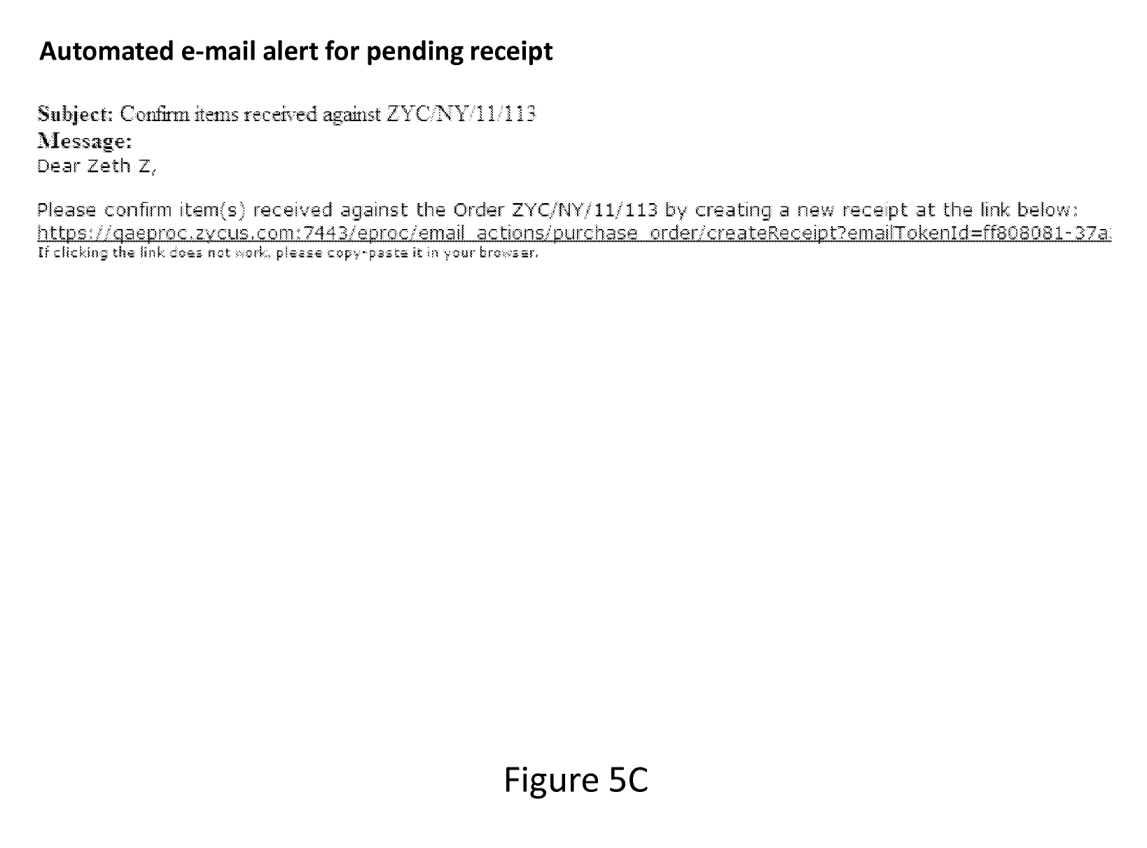

An exemplary flowchart 400 illustrating steps in a method for desktop receiving according to an embodiment of the present invention is shown in FIG. 4. As shown in FIG. 4, the method permits filling the requisition form at step 410. According to an embodiment of the present invention which utilizes computer apparatus, the filling the requisition form can be performed by way of input from the user in a computer screen (an exemplary computer screenshot for filling requisition order according to a specific embodiment is illustrated in FIG. 5A). The filled-in requisition form can be stored for order processing.

Further at step 420, the method permits generating goods receipts. Goods receipts can identify the ordered goods that were actually received. In desktop receiving, the goods can be delivered directly to the user, without the procurement department being necessarily in the receiving path. In a specific embodiment, upon receiving the goods, the user can access the requisition form that was earlier filled and then acknowledge the receipt of one or more goods in the requisition form. This then generates the respective goods receipts. The process of accessing the requisition form and acknowledging the goods receipt is also called as “flipping” the requisition order into goods receipt. An exemplary computer screenshot for flipping the requisition order according to a specific embodiment is illustrated in FIG. 5B.

In a specific embodiment, the system permits the user to generate goods receipts for items that are not previously confirmed to be received, for example, up to a quantity equal to ordered quantity minus the previously received quantity. In an embodiment, a tolerance level is also permitted. For example, the system permits user go generate goods receipt within tolerance limit of the quantity not previously confirmed to be received. The tolerance can be specified using any appropriate method such as absolute number, percentage, etc. For example, if the tolerance limit for receiving an item of stationery is 5, the user has ordered 100 units and previously received 80 units, the system permits user to now generate goods receipts up to 25 units.

According to an embodiment of the present invention which utilizes computer apparatus, the flipping the requisition order into goods receipt can be performed by way of input from the user in a computer screen. When flipping, user can select the ordered items in the requisition order. Against these items, the user can enter the received and approved quantities. Receiving tolerances can also be applied to the quantity based on the type/category of the item. Shipping information such as consignment/packing slip number, airway bill (AWB) number, shipper, shipped on, received on, etc. can also be inputted. Comments and attachments (to dematerialize physical documents) can be entered for the entire receipt or for the individual line items. For capital goods/assets items, an asset number (manual or auto-generated) can be provided for each individual item. Receiving users can also rate the supplier and/or item, which can then be normalized and shown to users purchasing it at a later point in time for comparison purposes. This information can also be used in rating the supplier performance.

In a specific embodiment, if any items are unapproved by the users, the users can be automatically prompted to create a goods return note. They can also visit the shipper's website to get the unique return shipment code. When returning the goods, users can indicate if the returned goods will be replaced and by when, or whether the quantity is to be blocked.

At step 430, the method can compare the requisition orders created in step 410 with the goods receipts generated in step 420. In a specific embodiment, the comparison can be performed at predetermined intervals, e.g., periodic, end of certain accounting periods, etc. In an alternative specific embodiment, the comparison can be performed when requested. Yet alternatively, comparison can be performed whenever goods receipt is generated.

Based upon the comparison, the method can generate one or more indications in step 440. In an embodiment, the indications can include reports that can be generated by the procurement department/finance department for reconciling received goods against requisition orders. Alternatively or in addition, the indications can include alerts which can be generated and transmitted to users. For example, alerts can be generated on missing goods, i.e., goods for which requisition request is created, but corresponding goods receipt is not yet generated by the expected delivery date. In a specific embodiment, the alert can be transmitted to the procurement department and/or the requester by email. The email can include a hyperlink referencing the requisition order for which the goods receipt is missing. The user can access the corresponding requisition order at the specified hyperlink. Alternatively, user can also confirm the receipt of goods by replying to the email with specific keywords. As merely an example, ALL in subject line of email reply can indicate that all pending items mentioned in the email have been received. Templates for the email alerts can be configurable. An exemplary email alert according to a specific embodiment is illustrated in FIG. 5C.

Accordingly, the present invention provides computer based desktop receiving system and method. While specific embodiments are described herein, alternative embodiments will be apparent to person of ordinary skill in the art, in which one or more acts described herein can be modified, performed in different order, or omitted, without departing from the spirit of the invention. Moreover, one or more acts can be added to those described herein. Such alternatives and modifications are included within the scope of the present invention.

What is claimed is:

1. A computer based procurement system, the system comprising:
a processor unit; and
a computer readable medium storing instructions executable by the processor unit to perform the steps of:
receiving requisition orders for goods;
receiving inputs confirming receipt of goods, wherein the inputs confirming the receipt are generated by flipping the associated requisition orders;
analyzing the goods receipts against the requisition orders using one or more predetermined criteria; and
generating indication for missing goods, based at least on the analyzing.

2. The system of claim 1 wherein the analyzing including determining whether goods receipt is confirmed for at least one of the requisition orders by a predetermined time.

3. The system of claim 1 wherein the analyzing including comparing the requisition orders against the confirmed goods receipts to identify missing goods.

4. The system of claim 3 wherein the comparing being comparing within a predetermined tolerance.

5. The system of claim 4 wherein the predetermined tolerance being specified as absolute number and/or percentage.

6. The system of claim 1 wherein the indication comprising a report showing the goods receipts in relation to the requisition orders.

7. The system of claim 1 wherein the indication comprising an alert associated with a missing goods receipt.

8. The system of claim 7 wherein the computer readable medium storing further instructions executable by the processor unit to perform the step of receiving a user input responsive to the alert.

9. The system of claim 8 wherein the user input responsive to the alert confirming that one or more items associated with the missing goods receipt being not received.

10. The system of 8 wherein the user input responsive to the alert confirming that one or more items associated with the missing goods receipt being received.

11. A computer based procurement method comprising:
receiving requisition orders for goods;
receiving inputs confirming receipt of goods, wherein the inputs confirming the receipt are generated by flipping the associated requisition orders; analyzing the goods receipts against the requisition orders using one or more predetermined criteria;
generating indication for missing goods, based at least on the analyzing.

12. The method of claim 11 wherein the analyzing including determining whether goods receipt is confirmed for at least one of the requisition orders by a predetermined time.

13. The method of claim 11 wherein the analyzing including comparing the requisition orders against the confirmed goods receipts to identify missing goods.

14. The method of claim 13 wherein the comparing being comparing within a predetermined tolerance.

15. The method of claim 14 wherein the predetermined tolerance being specified as absolute number and/or percentage.

16. The method of claim 11 wherein the indication comprising a report showing goods receipt in relation to the requisition orders.

17. The method of claim 11 wherein the indication comprising an alert associated with a missing goods receipt.

18. The method of claim 17 further comprising receiving a user input responsive to the alert.

19. The method of The system of claim 18 wherein the user input responsive to the alert confirming that one or more items associated with the missing goods receipt being not received.

20. The system of 18 wherein the user input responsive to the alert confirming that one or more items associated with the missing goods receipt being received.
